(19) United States
(12) Patent Application Publication
(10) Pub. No.: US 2022/0264930 A1
(43) Pub. Date: Aug. 25, 2022

(54) SHELF-STABLE, EXTRUDED FOOD PRODUCTS

(71) Applicant: H.J. Heinz Company Brands LLC, Pittsburgh, PA (US)

(72) Inventor: Martin Hanke, BR's-Hertogenbosch (NL)

(21) Appl. No.: 17/629,222

(22) PCT Filed: Jul. 15, 2020
(86) PCT No.: PCT/US2020/042041

§ 371 Date: Jan. 21, 2022

Related U.S. Application Data
(60) Provisional application No. 62/877,655, filed on Jul. 23, 2019.

(51) Int. Cl. A23P 30/25; A23L 7/122

(52) U.S. Cl. CPC A23P 30/25; A23L 7/122

(57) ABSTRACT

Shelf-stable, extruded food products are provided which are suitable for young children due to their fast-melting characteristic. The food products include at least an extruded cereal component with a crunchy but also soft texture. The cereal component includes soft flour, fiber, carbonate, and milk powder. The cereal component is also characterized by limited fat and sugar content. The extruded food products may optionally include one or more fillings. The extruded food products have a shelf life of at least about 6 months when stored at about 20° C. in sealed packaging.

### FIELD

The present disclosure relates to shelf-stable, extruded food products suitable for young children.

### BACKGROUND

For infants, the change from an exclusive milk diet to other types of food is a developmental milestone. When an infant is first introduced to solid foods, the foods tend to have a slightly viscous liquid consistency, such as rice cereals mixed with milk or water. Infants are often later introduced to pureed or mashed fruits and vegetables. Over time, infants may express interest in feeding themselves and may be given small finger foods, such as small pieces of soft fruit, vegetables, pasta, or crackers.

With more exposure to solid foods, the infant will continue to improve in their ability to eat a variety of food textures and larger pieces of food. Certain solid foods may be given to the infant even if the infant has few or no teeth because the infant's gums are able to mash soft foods to a suitable size to be swallowed. The child may also be introduced to nutritional snack foods. A popular snack for infants and toddlers includes O-shaped crackers or puffs which are relatively small in size. A drawback to these snacks is that infants may lack the finger dexterity necessary to pick up the small pieces or to place the pieces in their mouths.

Some soft-textured food products for young children on the market today are touted as having a meltable texture. To provide a soft texture to the product, food manufacturers often include significant sugar content. For example, freeze-dried yogurt snacks are available. However, these yogurt snacks often have a high sugar content and tend to be sticky as they can begin to melt on the child's fingers.

There remains consumer demand for snack foods that are safe and nutritious for toddlers and also infants that are relatively new to eating solid foods.

### SUMMARY

Provided herein are shelf-stable food products that include an extruded cereal component having a melt-in-the-mouth texture. These shelf-stable products are advantageously suitable for young children.

In one aspect, the food product includes an extruded cereal component comprising less than about 8 percent moisture by total weight of the cereal component; about 60 percent to about 90 percent soft flour by dry weight of the cereal component; about 5 percent to about 30 percent fiber by dry weight of the cereal component; about 2.5 percent to about 4.25 percent milk powder by dry weight of the cereal component; and about 0.5 percent to about 2 percent carbonate by dry weight of the cereal component.

In one particular embodiment, the soft flour comprises corn flour and rice flour. In one aspect, the carbonate comprises calcium carbonate. In another aspect, the fiber comprises soluble fiber, and may specifically comprise one or more of soluble corn fiber and inulin. In yet another aspect, the soluble fiber may comprise both soluble corn fiber and inulin.

In one aspect, the extruded cereal component has a limited sugar and/or fat content. In another approach, the extruded cereal component has both a limited sugar and fat content. For instance, the cereal component includes less than about 12 percent total sugar by dry weight of the cereal component. In another aspect, cereal component includes less than about 2 percent total fat by dry weight of the cereal component.

In yet another approach, the amount of pregelatinized starch included in the product mixture prior to extrusion may be limited. In one aspect, the cereal component comprises less than about 5 percent pregelatinized starch by dry weight of the cereal component. In another aspect, the cereal component comprises 0 percent pregelatinized starch.

If desired, the shelf-stable food product may further comprise one or more fillings having a water activity of less than about 0.6, in another aspect about 0.5 to about 0.6. The cereal component may also have a water activity of less than about 0.6, in another aspect about 0.5 to about 0.6.

In another aspect, a filling included in the shelf-stable food product may also have a limited total sugar content. In one approach, the filling has a total sugar content of less than about 30 percent sugar by weight of the filling.

The cereal component may be provided in any desired shape, such as in the shape of at least one of a tube, square, circle, star, triangle, rectangle, and flower.

### BRIEF DESCRIPTION OF THE DRAWINGS

FIG. 1 shows a food product according to the present disclosure.

FIG. 2 shows another food product according to the present disclosure.

FIG. 3 is a flowchart of an exemplary process for making a shelf-stable, extruded food product with a melt-in-the-mouth texture.

### DETAILED DESCRIPTION

The present disclosure relates to shelf-stable food products comprising an extruded cereal component with a melt-in-the-mouth texture. Because of the product's meltability, the extruded food products are suitable for consumption by young children, such as infants and toddlers of at least 12 months of age. The extruded food products described herein can be used to expose young children to a broader range of food textures. The extruded food products also can be used to promote self-feeding and hand-eye coordination.

The extruded cereal component provided herein advantageously has a crispy, porous texture that is fast melting in the mouth. The combination of ingredients used to make the extruded cereal component provide small pores and thin cell walls, which contribute to the melt-in-mouth texture. It was surprisingly found that these results can be achieved without including significant fat or sugar content in the cereal component, as described in more detail below. In at least one embodiment, the shelf-stable extruded food product may further comprise one or more fillings.

The food products described herein retain a crispy but fast-melting texture of the cereal component throughout its shelf life. For purposes herein, the term “shelf-stable” means that the texture, taste, and overall perception of the product is maintained for at least about 6 months, in another aspect at least about 9 months, in another aspect at least about 12 months, when stored at 20° C. in sealed packaging.

As used herein, the terms “fast melting,” “meltability,” or “melt-in-the-mouth” texture or similar terms means that the extruded cereal component or a bite-sized portion of a larger extruded cereal component dissolves sufficiently in the mouth without chewing in less than about 45 seconds, in another aspect in less than about 30 seconds, in another aspect in less than about 15 seconds to allow the food to be swallowed.

The extruded cereal components provided herein generally comprise flour, fiber, milk powder, and a carbonate while including a limited quantity of total fat and total sugar. The dry ingredients are mixed and then combined with water in an amount suitable for extrusion. The resulting extruded cereal component has a crunchy texture but yet is soft enough for the gums and soft palate of young children.

The cereal component of the food product comprises at least one soft flour. In one aspect, the dry ingredients forming the cereal component include about 60 percent to about 90 percent soft flour, in another aspect about 65 percent to about 85 percent soft flour, and in another aspect about 70 percent to about 80 percent soft flour, with all percentages based on the dry weight of the cereal component.

The flour useful herein is non-pregelatinized “soft” flour (i.e., the starch in the flour is native starch in crystalline form). As used herein, the term “soft flour” refers to a flour having less than 12 percent protein, in another aspect less than about 10 percent protein, and in another aspect less than about 8 percent protein, and the starch therein is not gelatinized prior to extrusion. Generally, finely ground flours are preferred. It was found that the selection of flour impacts the structure, texture, taste, and color of the cereal component. In one approach, the flour component comprises a “soft” flour such as rice flour, corn flour, wheat flour, and combinations thereof. The soft flours generally are effective to provide extruded products having a finer texture and faster melting in the mouth. Soft flours can also be referred to as cake flour and pastry flour. The soft flour may or may not include gluten.

Combinations of soft flours may also be included, if desired. For example, a combination of rice flour and corn flour have been found to be advantageous. In one aspect, the amount of corn flour and rice flour can each range from about 10 percent to about 90 percent of the total weight of the flour component. In another aspect, the corn flour and rice flour are each included in an amount of from about 25 percent to 75 percent by weight of the flour component. In another aspect, the corn flour and rice flour are each included in an amount of from about 35 percent to 65 percent by weight of the flour component. In one particular approach, the corn flour is included in an amount of about 30 percent to about 45 percent and the rice flour is included in an amount of about 55 percent to about 70 percent, by weight of the flour component. In another particular approach, the corn flour is included in an amount of about 35 percent to about 40 percent and the rice flour is included in an amount of about 60 percent to about 65 percent, by weight of the flour component.

Generally, it was found that flours having a higher protein content, including quinoa flour and buckwheat flour, provide extruded products with a harder texture and low meltability in the mouth. As used herein, the term “hard” flour refers to a flour having 8 percent or more protein, in another aspect 10 percent or more protein, and in another aspect 12 percent or more protein. It was found that extruded products made with these flours were crispy but formed undesirably sharp edges when snapped or chewed. Use of more than about 20 percent of hard flour, in another aspect more than about 10 percent hard flour, by weight of the cereal component is generally undesirable for preparing the extruded products for children described herein. In one particular approach, 0 percent of these flours is included.

The cereal component further comprises a fiber source. In one approach, the cereal component comprises about 5 percent to about 30 percent fiber, in another aspect about 10 percent to about 25 percent fiber, and in another aspect about 15 percent to about 20 percent fiber, with all percentages based on the dry weight of the cereal component. The fiber source may include insoluble fiber, soluble fiber, or a combination of soluble and insoluble fiber. Insoluble fiber sources may include, for example, soy fiber, oat fiber, apple fiber, and combinations thereof. Soluble fiber sources nay include, for example, inulin, soluble corn fiber, fructooligosaccharide, oligofructose, maltodextrin, polydextrose, and combinations thereof. One particularly suitable soluble corn fiber product is PROMITOR® SGF 70R from Tate & Lyle.

In one particular aspect, the cereal component comprises about 5 percent to about 30 percent soluble fiber, in another aspect about 10 percent to about 25 percent soluble fiber, and in another aspect about 15 percent to about 20 percent soluble fiber, with all percentages based on the dry weight of the cereal component. It was found that the soluble fiber contributes to stability of the cereal component during extrusion, as well as provides a desired texture and melting behavior to the cereal component.

In one particular approach, the soluble fiber source comprises a combination of inulin and soluble corn fiber. In one aspect, the inulin and soluble corn fiber are each included in an amount of from about 35 percent to about 65 percent by weight of the soluble fiber source. In another approach, the inulin is included in an amount of about 35 percent to about 55 percent and the soluble corn fiber is included in an amount of about 45 percent to about 65 percent, by weight of the soluble fiber source. In another approach, the inulin is included in an amount of about 40 percent to about 55 percent and the soluble corn fiber is included in an amount of about 45 percent to about 60 percent, by weight of the soluble fiber source. In another particular approach, the inulin is included in an amount of about 40 percent to about 50 percent and the soluble corn fiber is included in an amount of about 50 percent to about 60 percent, by weight of the soluble fiber source. It was found that a combination of inulin and soluble corn fiber is effective to mimic the properties of maltodextrin but without the accompanying drawbacks of maltodextrin, which is high on the glycemic index.

In at least one approach, it is preferred that pregelatinized starches are specifically avoided or the quantity limited in the cereal component. For example, it was found that inclusion of waxy maize starch adversely impacted the desired texture and meltability of the extruded cereal component. At least in one aspect, the cereal component includes less than about 5 percent, in another aspect less than about 2 percent, in another aspect 0 percent, pregelatinized starch by dry weight of the cereal component. In one aspect, it is contemplated that the cereal component includes less than about 5 percent, in another aspect less than about 2 percent, in another aspect 0 percent, waxy maize starch by dry weight of the cereal component.

The cereal component further comprises milk powder. In one aspect, cereal component comprises about 2 percent to about 10 percent milk powder, in another aspect about 2 percent to about 8 percent milk powder, in another aspect about 3 percent to about 5 percent milk powder, in another aspect about 2 percent to about 4.5 percent milk powder, and in another aspect about 2.5 percent to about 4.25 percent milk powder, with all percentages based on the dry weight of the cereal component. The milk powder may be selected from, for example, non-fat dry milk, skimmed milk powder, whole milk powder, buttermilk powder, whey powder, and combinations thereof. In one currently preferred approach, the milk powder is skimmed milk powder. It was found that inclusion of the milk powder contributes to the meltability, flavor, and extrudability of the cereal component. When selecting the milk powder(s) for inclusion in the cereal component, care is taken to limit the total sugar content of the cereal component as described herein.

The cereal component further comprises a carbonate. In one aspect, cereal component comprises about 0.5 percent to about 2 percent carbonate, in another aspect about 0.6 percent to about 1.5 percent carbonate, and in another aspect about 0.7 percent to about 1 percent carbonate, with all percentages based on the dry weight of the cereal component. In one preferred approach, the carbonate comprises calcium carbonate. It was found that inclusion of the carbonate contributes to the extruded structure and meltability of the cereal component.

In one approach, the cereal component includes very low total fat content. For purposes herein, the total fat content is calculated based on the fat content contributed by any ingredient of the cereal component. In one aspect, the total fat by dry weight of the cereal component is less than about 2 percent fat, in another aspect less than about 1.5 percent fat, and in another aspect less than about 1.0 percent fat.

In one approach, the extruded product includes little to no added sugar. Added sugars include, for example, carbohydrate sweeteners, such as sucrose, fructose, lactose, glucose, in liquid or dry form. For purposes herein, maltodextrin is considered a sugar clue to its effect on the glycemic index. In one aspect, the snack product includes less than 12 percent total sugar content, in another aspect less than about 10 percent total sugar, in another aspect less than about 8 percent total sugar, in another aspect less than about 6 percent total sugar, in another aspect less than about 4 percent total sugar, and in another aspect less than about 3 percent total sugar by weight of the snack product. The total sugar content is calculated based on the sugar content contributed by any ingredient of the snack product. For example, skimmed milk powder typically includes up to about 50 percent lactose. Therefore, any lactose contributed by the skimmed milk powder would be included in the total sugar content of the product. Any separately added sugars, such as granular sucrose or liquid fructose, would also be included in the total sugar calculation.

In yet another aspect, both the cereal component and any filling included in the product also have limited total sugar content. In one aspect, the cereal component also includes less than about 12 percent total sugar content, in another aspect less than about 8 percent total sugar, in another aspect less than about 6 percent, in another aspect less than about 4 percent total sugar, and in another aspect less than about 3 percent total sugar by weight of the cereal component. In another aspect, the filling component(s) also includes less than about 30 percent total sugar content, in another aspect less than about 20 percent total sugar, and in another aspect less than about 15 percent total sugar by weight of the filling.

If desired, enzymes may be included in the dry mixture, such as to reduce acrylamide formation during the extrusion process. Suitable enzymes include, for example, Acrylaway from Novozymes.

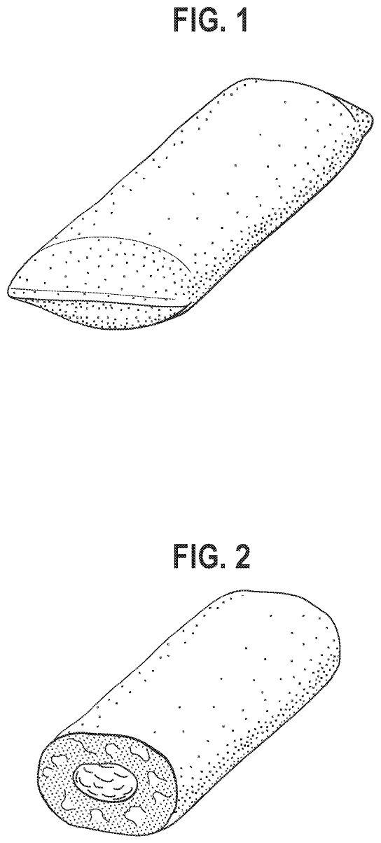

The extruded product may be provided in a number of shapes, such as a tube, square, circle, star, triangle, rectangle, flower, and the like. The shape of the extruded product is not particularly limited, though a presently preferred shape is a tube shape, such as a hollow tube. The tube can be provided in a variety of lengths. During manufacture, the tube can be cut by any suitable apparatus, such as a rotary cutter comprising multiple knives. The cutting of the tube can “pinch” the ends of the tube to provide a closed product, such as shown in FIG. 1. In that approach, a filling may be entirely encased by the tube.

In one form, the extruded food product may include one or more fillings. When included, the filling generally has a low water activity and creamy texture. The filling can be made by mixing filling ingredients, such as liquid oil, milk powder, emulsifier, flavor component, milk powder, and starch source, in amounts effective to provide the filling component having a water activity of less than about 0.6. For example, the starch source may be selected to provide a firm texture to the filling. The milk powder may be selected to provide a soft, fast-melting texture to the filling.

Water activity is a well-known method for characterizing the presence of water. Water activity is measured as the ratio between the vapor pressure of water in an enclosed chamber containing a food and the saturation vapor pressure of water at the temperature. Water activity indicates the degree to which water is bound and, subsequently, available to act as a solvent or participate in destructive chemical and microbiological reactions. When the water activity is low, water is unavailable because it is tightly bound to surface polar sites through chemisorption. Water activity is defined as:

$${a}_{w} = \frac{p}{{P}_{0}}$$

where a_{w} is water activity, p is the partial pressure of water above the sample, and P₀ is the vapor pressure of pure water at the same temperature (must be specified). Another definition of water activity which is more thermodynamically appropriate is

$${a}_{w} = \frac{{P}_{eq}}{{P}_{0}}$$

where P_{eq} is the partial vapor pressure of water in equilibrium with the solution and P₀ is the vapor pressure of pure water at the same temperature and pressure as the solution. When a solute is added to water, water molecules are displaced by solute molecules, and the ratio of the vapor pressures or a_{w} is altered. Entropy is also lowered as solute molecules become oriented to water molecules. As a result, water molecules are not as free to escape from the liquid phase and the vapor pressure is therefore decreased. This change is governed by Raoult's law, which states that the decrease in vapor pressure of a solution is equal to the mole fraction of its solute. Similarly, the ratio of vapor pressures (a_{w}) is governed by the number of moles of solute (n₁) sand solvent (n₂):

$${a}_{w} = \frac{P}{{P}_{0}} = \frac{{n}_{1}}{{n}_{1} + {n}_{2}}$$

Different solutes tie up or bind water to varying degrees depending on the nature of the solute, such as its level of dissociation, extent and nature of intramolecular binding, solubility and chemical components.

Over the shelf life of the extruded food product, water present in either the cereal component and optional filling(s) can move or equilibrate among the components, which may adversely impact the desired texture of either or both components. For example, the cereal component can take on a ‘soggy’ texture as moisture migrates away from the filling, which also can leave the filling dry and crumbly. Similarly, moisture can migrate from a higher water activity cereal component into the filling, which can leave the cereal component with a dried out and tough texture. Therefore, it is generally desirable to provide cereal component with a water activity of about 0.4 to about 0.65, in another aspect about 0.45 to about 0.65, and in another aspect about 0.5 to about 0.6, and any fillings present in the product would also have a water activity of less than about 0.65, in another aspect about 0.4 to about 0.65, in another aspect about 0.45 to about 0.65, and in another aspect about 0.5 to about 0.6.

In one approach, the extruded cereal component has a moisture content of about 4 percent to about 8 percent, in another aspect about 5 percent to about 7 percent by weight of the cereal component.

For savory fillings, the filling may include a vegetable flavoring, such as carrot, tomato, bell pepper, broccoli, red beet, sweetcorn, spinach, pumpkin, courgette, parsnip, pea, and combinations thereof. Preferred flavorings include natural flavorings. The flavoring may be provided by any suitable flavor ingredient, such as liquid flavorings, powdered flavorings, essential oils, spices, and combinations thereof. For example, the flavoring may include dried vegetable powders, dried herb powders, conventional flavorings such as vanillin, and the like. At least in one approach, the filling has a savory flavor. Generally, the filling ingredients are selected to provide a soft, creamy texture.

Exemplary oils and fats for the filling include vegetable oil (i.e., melting point of 22° C. or lower), solid fat (i.e., melting point above 22° C.), shortening, dairy fat, milk fat, butter, and combinations thereof. The oil may be a hydrogenated oil. Suitable vegetable oils include but are not limited to palm, corn, canola, sunflower seed, cottonseed, and soybean oil, and combinations thereof.

The filling may be applied to the cereal component via any suitable method known in the art. For example, a cereal component with filling may be achieved using coextrusion. The filling may be pumped from a vessel located near the extruder.

The filling may be provided entirely within the cereal component or may be partially exposed. In one aspect, the extruded food product may be provided in the shape of a hollow tube and the tube may be filled with a flavored filling. The filling may be exposed at the ends of the tube, such as shown in FIG. 2. In another approach, the tube ends may be pinched closed during manufacture so that the filling is not visible until the product is cut or eaten by the consumer. FIG. 1 depicts a tube with closed ends.

An exemplary recipe for the cereal component for the shelf-stable extruded product described herein is provided in Table 1 below:

TABLE 1

| | Range | Preferred | More preferred |
|---|---|---|---|
| Cereal | (Percent by | (Percent by | (Percent by |
| Component | dry weight) | dry weight) | dry weight) |
| “Soft” Flour | 60-90 | 65-85 | 70-80 |
| Fiber | 5-30 | 10-25 | 15-20 |
| Milk powder | 2-10 | 2-8 | 2.5-4.25 |
| Carbonate | 0.5-2 | 0.6-1.5 | 0.7-1.0 |

In the formulations above in Table 1, in one particular embodiment, the soft flour comprises one or more of rice flour and corn flour, the fiber comprises one or more soluble fibers (in particular a combination of soluble corn fiber and inulin), the milk powder comprises skimmed milk powder, and the carbonate comprises calcium carbonate. In this embodiment, the cereal component includes a total fat content by dry weight of the cereal component of less than about 2 percent fat, in another aspect less than about 1.5 percent fat, and in another aspect less than about 1 percent fat, as well as has a total sugar content of less than about 12 percent, in another aspect less than about 8 percent, in another aspect less than about 6 percent, in another aspect less than about 4 percent, and in another aspect less than about 3 percent total sugar by weight of the cereal component.

The cereal component and optional filling(s) may also include any additional flavoring, coloring, vitamin, mineral, and other nutrient ingredients so long as they do not adversely affect the shelf life or organoleptic properties of the resulting extruded product. The cereal component and optional filling(s) may contain, for example, herbs and spices, small fruit or vegetable pieces, aroma ingredients, and combinations thereof. Exemplary vitamins and minerals include vitamin A, vitamin B1, vitamin B2, vitamin B6, vitamin B12, vitamin C, vitamin. D, vitamin E, vitamin K, biotin, calcium, choline, copper, folic acid, inositol, iodine, iron, L-carnitine, magnesium, manganese, niacin, pantothenic acid, phosphorous, potassium, sodium, selenium, taurine, zinc, and combinations thereof.

The composition of the optional filling can vary depending on the desired finished product flavor profile. By one approach, the filling further comprises a flavor component, including, for example, vegetable, cheese, yogurt, meat, processed cheese, fruit, or any combination thereof. The flavor component is provided in amounts effective to provide the desired savory flavor to the filling. In one aspect, the flavor component comprises a tomato flavor (such as a tomato powder). In another aspect, the flavor component comprises a carrot flavor.

By another approach, the flavor component may include a cheese powder, yogurt, processed cheese, micromilled cheese, cheese paste, or the like to provide a cheesy flavor to the filling. The cheese powder or paste ingredients can be prepared from any cheese type, including, for example, processed cheese, natural or artificial cheese. Exemplary cheese powders include commercially available cheese powders prepared from natural or processed cheeses. The cheese powder may be any flavor cheese, such as cheddar cheese, Swiss cheese, American cheese, provolone cheese, mozzarella cheese, Parmesan cheese, blue cheese, Monterey lack cheese, Romano cheese, cream cheese, Havarti cheese, Gouda cheese, Muenster cheese, Asiago cheese, Gorgonzola cheese, or a combination thereof. The particular flavor or combinations of flavors can be selected to provide the desired flavor profile to the filling.

### Method of Making

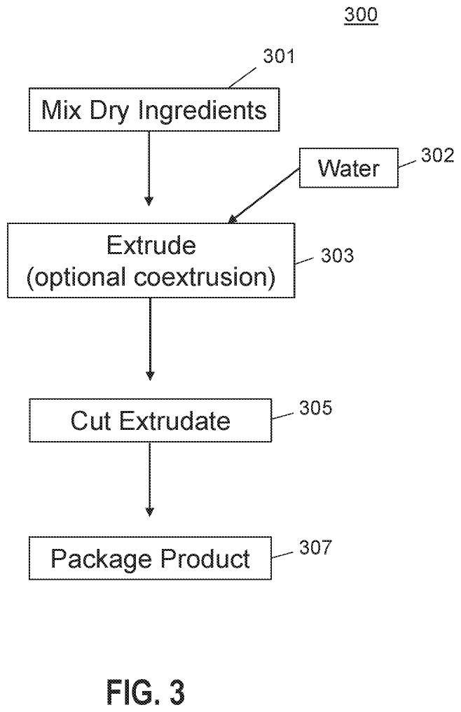

An exemplary method for making the extruded cereal component is provided in FIG. 3. To form the extruded food product, in one approach, the dry ingredients are mixed in step 301 to obtain a dry mixture. The dry ingredients may be mixed for any suitable length of time to obtain a generally homogenous mixture. The dry mixture is then dosed into an extruder, such as a twin screw extruder. A controlled amount of water 302 (for example, about 2 percent to about 10 percent water by weight of the dry mixture, in another aspect about 3 percent to about 7 percent water by weight of the dry mixture) is added to the dry mixture in the extruder. The mixture is then heated up to about 100° C. The heating can occur in multiple stages, if preferred. The speed of rotation of the twin screws can be any appropriate speed and will depend in part on the diameter of the extruder. While in the extruder, the dry mixture becomes a cooked wet mass. The dry mixture is conveyed through one or more dies at the end of the extruder 303 to form the cereal component into the desired shape. The twin screws create a consistent volume flow of the extrusion mix, but the diameter decreases within the extruder. Just before the dies and at the dies itself, the cross-sectional area is minimized and the pressure significantly increases. Upon exiting the extruder, the extrudate is at ambient pressure. Because of the change in pressure, the trapped water inside the starch of the flour immediately starts boiling/evaporating to create a porous texture to the cereal component.

After extrusion, the product may be conveyed to a cutting apparatus in cutting step 305 to cut the extruded cereal component into pieces with a defined length. In one approach, the cutting apparatus may be a rotary cutter. For instance, the cereal component may be cut into tubes having a length of about 75 to about 125 mm.

Generally, no specific cooling step is required upon exiting the extruder. The product will quickly begin to develop a crunchy texture (within about 2 minutes) at room temperature (about 20° C.). Refrigeration or blast cooling is not needed to achieve the desired texture.

As discussed above, if one or more fillings are included, the filling(s) may be applied to the cereal component via any suitable method known in the art. For example, a cereal component with filling may be achieved using coextrusion, for example. In another approach, the cereal component may be extruded and the filling later added, such as by injection of the filling into the cereal component.

The extruded products may then be packaged in step 307 in any suitable packaging, such as in flow-wrap, pouch, tray, envelope, or the like. By one approach, one or more of the food products are wrapped in a package formed of plastic film, metal foil, or laminates containing one or more of these materials. The materials employed for the packages may include oxygen-impermeable barriers and/or water barriers, if desired. Advantageously, the food product does not have to be packaged using aseptic conditions, although aseptic conditions can be used, if desired. The food product has a shelf life of at least about 6 months, in another aspect at least about 9 months, in another aspect at least about 12 months when stored at about 20° C. in sealed film packaging.

The following examples are intended to illustrate the shelf-stable, extruded food products and methods provided herein and not to limit or otherwise restrict the disclosure. Unless indicated otherwise, all parts, ratios, and all percentages are based on weight.

### Example

Extruded cereal components were prepared. Dry ingredients were mixed according to the formulations in Table 2 below.

TABLE 2

| | Sample 1 | Sample 2 | Sample 3 | Sample 4 | Sample 5 |
|---|---|---|---|---|---|
| | (% by dry | (% by dry | (% by dry | (% by dry | (% by dry |
| | weight) | weight) | weight) | weight) | weight) |
| Rice flour | 51 | 51 | 50.2 | 45.2 | 47.2 |
| Buckwheat | 30 | 0 | 0 | 0 | 0 |
| flour | | | | | |
| Corn flour | 0 | 30 | 30 | 30 | 30 |
| Inulin | 15 | 10 | 10 | 10 | 8 |
| Soluble corn | 0 | 5 | 5 | 5 | 10 |
| fiber | | | | | |
| Waxy maize | 0 | 0 | 0 | 5 | 0 |
| starch | | | | | |
| Quinoa flour | 4 | 0 | 0 | 0 | 0 |
| Skim milk | 0 | 4 | 4 | 4 | 4 |
| powder | | | | | |
| Calcium | 0 | 0 | 0.8 | 0.8 | 0.8 |
| carbonate | | | | | |
| Total | 100 | 100 | 100 | 100 | 100 |

The dry ingredients were mixed for about 15 minutes and then dosed into a twin screw extruder. A controlled amount of water (about 5 percent by weight of the dry mixture) was added to the dry mixture in the extruder. The mixture was then heated up to about 100° C. The speed of rotation of the twin screws was generally about 70-90 rpm but the speed will be highly dependent on the extruder dimensions. After extrusion, the cereal component was conveyed to a cutting apparatus and cut to a length of about 100 mm.

Of the formulations listed in Table 2 above, the formulation of Sample A had the least desirable texture. The texture was very crunchy and broke with sharp edges upon biting. The texture was undesirable for a food product intended for small children.

Sample 2 provided a clear improvement over sample 1—the texture was less firm and the structure of sharp edges was reduced. However, bubble size (internal structure) of the extruded product was still comparable to Sample 1 and therefore meltability was limited. Sample 3 was further improved over Sample 2. The internal structure showed finer/smaller bubbles which contributed to meltability and a suitable texture for infants/toddlers.

Sample 5 performed even better than Sample 3 and provided a more beneficial texture. Sample 4 was similar to Sample 5 but further included waxy maize starch as a portion of the soluble fiber content. Inclusion of waxy maize starch increased expansion during extrusion but did not provide a soft enough texture. The waxy maize starch also decreased the meltability of the cereal component.

Overall, Sample 5 had the most desirable crunchy but soft texture and rapid melting characteristic in the mouth.

The foregoing descriptions are not intended to represent the only forms of the food products in regard to the details of formulation. Changes in form and in proportion of parts, as well as the substitution of equivalents, are contemplated as circumstances may suggest or render expedient. Similarly, while food products and methods have been described herein in conjunction with specific embodiments, many alternatives, modifications, and variations will be apparent to those skilled in the art in light of the foregoing description.

1. A shelf-stable, extruded food product with fast melting texture suitable for young children, the food product including an extruded cereal component comprising:
less than about 8 percent moisture by total weight of the cereal component;
about 60 percent to about 90 percent soft flour by dry weight of the cereal component;
about 5 percent to about 30 percent fiber by dry weight of the cereal component;
about 2.5 percent to about 4.25 percent milk powder by dry weight of the cereal component; and
about 0.5 percent to about 2 percent carbonate by dry weight of the cereal component.

2. The shelf-stable, extruded food product according to claim 1, wherein the cereal component includes less than about 12 percent total sugar by dry weight of the cereal component.

3. The shelf-stable, extruded food product according to claim 1, wherein the cereal component includes less than about 2 percent total fat by dry weight of the cereal component.

4. The shelf-stable, extruded food product according to claim 3, further comprising one or more fillings having a water activity of less than about 0.6.

5. The shelf-stable, extruded food product according to claim 4, wherein the one or more fillings have a water activity of about 0.5 to about 0.6.

6. The shelf-stable, extruded food product according to claim 5, wherein the cereal component has a water activity of less than about 0.6.

7. The shelf-stable, extruded food product according to claim 6, wherein the cereal component is in the shape of at least one of a tube, square, circle, star, triangle, rectangle, and flower.

8. The shelf-stable, extruded food product according to claim 7, wherein the soft flour comprises corn flour and rice flour.

9. The shelf-stable, extruded food product according to claim 8, wherein the carbonate comprises calcium carbonate.

10. The shelf-stable, extruded food product according to claim 9, wherein the fiber comprises soluble fiber.

11. The shelf-stable, extruded food product according to claim 10, wherein the soluble fiber comprises at least one of soluble corn fiber and inulin.

12. The shelf-stable, extruded food product according to claim 11, wherein the soluble fiber comprises both soluble corn fiber and inulin.

13. The shelf-stable, extruded food product according to claim 12, further comprising a filling and the filling having a total sugar content of less than about 30 percent by weight of the filling.

14. The shelf-stable, extruded food product according to claim 13, wherein the cereal component comprises less than about 5 percent pregelatinized starch by dry weight of the cereal component.

15. The shelf-stable, extruded food product according to claim 14, wherein the cereal component comprises 0 percent pregelatinized starch.
